(19) United States
(12) Patent Application Publication
(10) Pub. No.: US 2009/0153618 A1
(43) Pub. Date: Jun. 18, 2009

(54) MANUFACTURING METHOD OF A LIQUID EJECTING HEAD AND A LIQUID EJECTING APPARATUS WITH SAID HEAD

(75) Inventor: Minoru Oguri, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/334,321

(22) Filed: Dec. 12, 2008

(30) Foreign Application Priority Data
Dec. 17, 2007 (JP) 2007-325195

(51) Int. Cl. B41J 2/16; G11B 5/127

(52) U.S. Cl. 347/44; 216/27

(57) ABSTRACT

Surfaces of second substrates of head members at the sides opposite to adhesion surfaces with first substrates face each other, the pair of head members is fixed to each other with a sealed space interposed between the surfaces of the second substrates at the sides opposite to the adhesion surfaces with the first substrates, and a solution treatment is performed with respect to the pair of head members fixed

[symbol]

### CROSS REFERENCES TO RELATED APPLICATIONS

The present invention contains subject matter related to Japanese Patent Application No. 2007-325195 filed in the Japanese Patent Office on Dec. 17, 2007, the entire contents of which are incorporated herein by reference.

### BACKGROUND OF THE INVENTION

1. Field of the Invention

The present invention relates to a manufacturing method of a liquid ejecting head and a liquid ejecting apparatus with said head.

2. Description of Related Art

As an ink jet recording head which is a liquid ejecting head, for example, an ink jet recording head in which pressure generation chambers communicating with nozzle openings are formed in a channel forming substrate, a piezoelectric element which is a pressure generation unit is formed on one surface of the channel forming substrate, and a protective substrate which covers the piezoelectric element on the side of the piezoelectric element of the channel forming substrate is adhered is disclosed in Japanese Unexamined Patent Application Publication No. 2006-272913. A reservoir portion configuring a portion of a common ink chamber of the pressure generation chambers is provided in the protective substrate of the ink jet recording head.

When such an ink jet recording head is manufactured, the piezoelectric element is formed on one surface of the channel forming substrate, the protective substrate is adhered to the channel forming substrate, and the pressure generation chambers are then formed by anisotropically etching the other surface of the channel forming substrate. In addition, a nozzle plate in which the nozzle openings are provided is adhered to the surface of the channel forming substrate, in which the pressure generating chambers are opened, via an adhesive.

Since a wiring member is provided on the surface of the protective substrate at the side opposite to an adhesion surface with the channel forming substrate, when anisotropic etching is performed, a protective film is adhered by an adhesive with a fluororesin (polytetrafluoroethylene) sheet or the like interposed therebetween. By covering the wiring member or the like by the protective film, an etchant is prevented from being adhered to the surface of the protective substrate on which the wiring member is provided. However, since the etching for forming the pressure generation chambers is performed by an alkali solution (KOH) heated to, for example, 70° C. to 80° C., although a protective film with low heat contraction is used, warpage may occur in the protective substrate and thus a load may be applied to a product. In addition, the adhesive or the protective film may be melted to the alkali solution and, when the adhesive or the protective film is melted, etching precision may deteriorate and the size of the pressure generation chambers or the like may be deviated. The same problems may occur even when a cleaning process of removing a foreign matter such as iron by adhering a film is performed.

### SUMMARY OF THE INVENTION

The invention is contrived to solve the above-described problems and can be realized as the following aspect or application example.

According to an aspect of the invention, there is provided a method of manufacturing a liquid ejecting head, including: configuring head members each including a first substrate in which pressure generation chambers are provided, pressure generation units which cause a pressure variation in the pressure generation chambers in order to eject liquid droplets from nozzle openings, and a second substrate adhered to the first substrate in a state of covering the pressure generation units, and facing surfaces of the second substrates of the head members at the sides opposite to adhesion surfaces with the first substrates each other, fixing the pair of head members to each other with a sealed space interposed between the surfaces of the second substrates at the sides opposite to the adhesion surfaces with the first substrates, and performing a solution treatment with respect to the pair of head members fixed to each other.

Features and advantages of the invention other than the above will become clear by reading the specification with reference to the accompanying drawings.

### BRIEF DESCRIPTION OF THE DRAWINGS

For complete understanding of the invention and the advantages thereof, reference is made to the following description taken in conjunction with the accompanying drawings.

FIG. 1 is an exploded perspective view of an ink jet recording head according to an embodiment of the invention.

FIG. 2 is a schematic plan view of the ink jet recording head of the invention.

FIG. 3 is a view taken along line III-III of FIG. 2.

FIG. 4 is a cross-sectional view of a state in which a second substrate is adhered.

FIG. 5 is a cross-sectional view of a state in which pressure generation chambers are formed.

FIG. 6 is a conceptual diagram of a state in which a first substrate is etched.

### DETAILED DESCRIPTION OF PREFERRED ASPECTS

At least the following will become apparent according to the specification and the accompanying drawings.

According to an aspect of the invention, there is provided a method of manufacturing a liquid ejecting head, including: configuring head members each including a first substrate in which pressure generation chambers are provided, pressure generation units which cause a pressure variation in the pressure generation chambers in order to eject liquid droplets from nozzle openings, and a second substrate adhered to the first substrate in a state of covering the pressure generation units, and facing surfaces of the second substrates of the head members at the sides opposite to adhesion surfaces with the first substrates each other, fixing the pair of head members to each other with a sealed space interposed between the surfaces of the second substrates at the sides opposite to the adhesion surfaces with the first substrates, and performing a solution treatment with respect to the pair of head members fixed to each other. In the invention, by fixing the second substrates to each other with the sealed space interposed therebetween, since a treatment solution is not infiltrated into the sealed space of each of the second substrates, the surfaces of the second substrates at the sides opposite to the adhesion surfaces with the first substrates can be protected. In addition, since the second substrates formed of the same material are fixed, the warpage can be eliminated regardless of the temperature of the treatment solution. Accordingly, even when the solution treatment is performed, it is possible to perform a treatment with high precision, without giving a load to a product. It is possible to eliminate a process of removing a protective film and an adhesive by laser or the like.

In the method of manufacturing the liquid ejecting head of the invention, the sealed space may be formed by interposing an O-ring between the surfaces of the pair of the second substrates at the sides opposite to the adhesion surfaces with the first substrates.

In the invention, it is possible to easily form the sealed space with certainty, by interposing the O-ring. The material of the O-ring is preferably rubber having solution resistance. For example, if a treatment is performed using an alkali solution, an O-ring formed of fluororubber with excellent alkali solution resistance is preferably employed.

In the method of manufacturing the liquid ejecting head of the invention, the edges of the pair of second substrates may be fixed by a fixing member.

In the invention, since the edges of the pair of second substrates are fixed by the fixing member, it is possible to fix the second substrates with certainty.

In the method of manufacturing the liquid ejecting head of the invention, wiring members may be formed on the surfaces of the second substrates at the side opposite to the adhesion surfaces with the first substrates, and the solution treatment may be a treatment for forming the pressure generation chambers by etching using an alkali solution. In the invention, when the pressure generation chambers are formed by etching using an alkali solution, it is possible to protect the wire members with certainty in a state in which the warpage of the second substrates are eliminated and to perform a treatment with high precision.

The invention relates to a liquid ejecting apparatus including the liquid ejecting head manufactured by the above-described method. Accordingly, it is possible to provide a liquid ejecting apparatus with high reliability.

Hereinafter, the exemplary embodiments of the invention will be described with reference to the accompanying drawings.

In addition, the following embodiments are described as examples of the invention, and all the components described herein are not necessary components of the invention.

### BEST EMBODIMENTS

Hereinafter, the embodiments will be described with reference to the drawings.

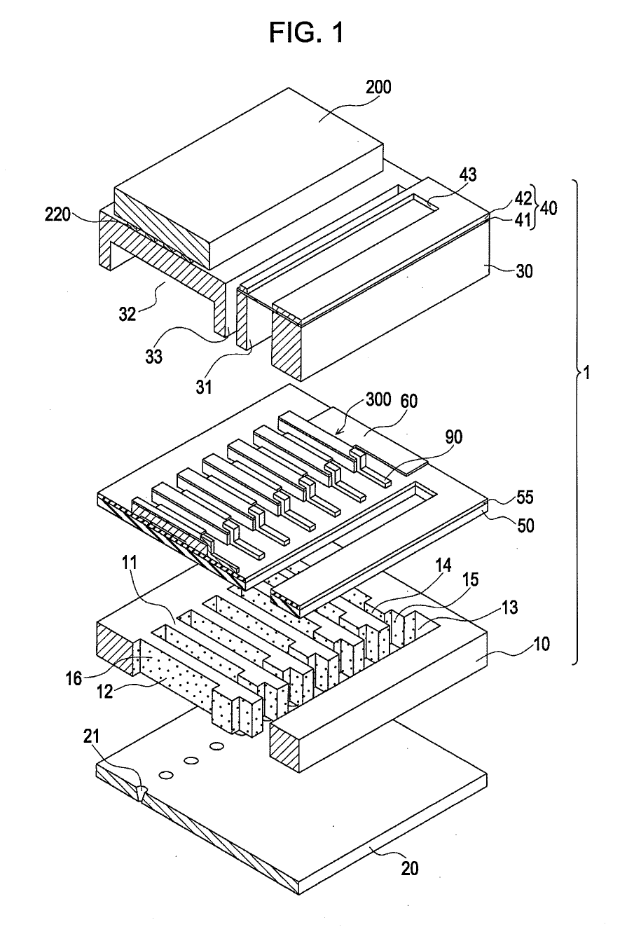

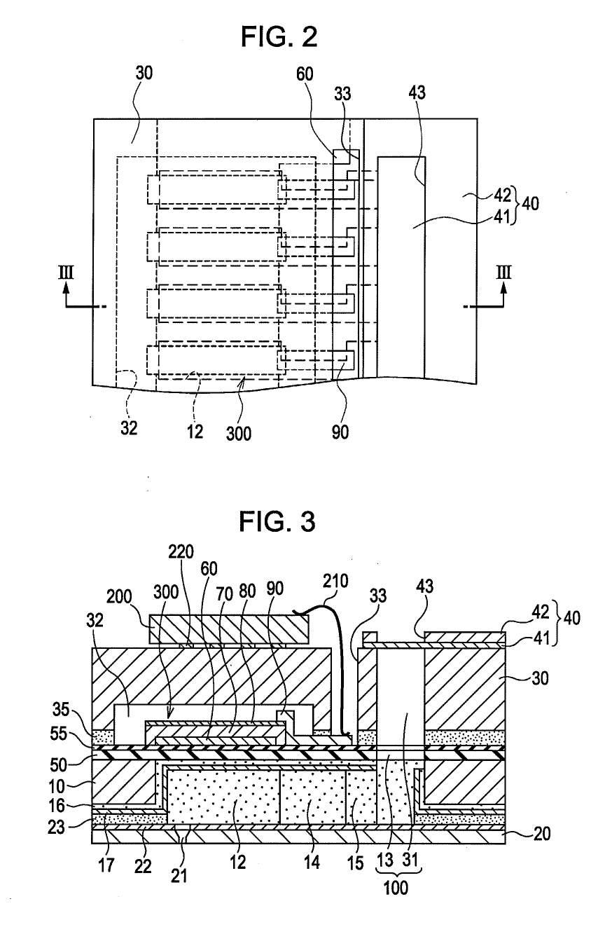

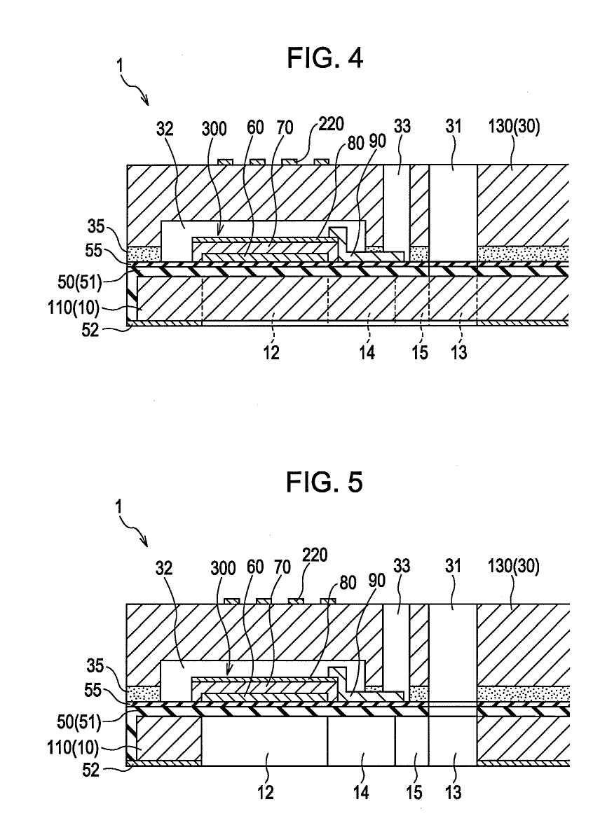

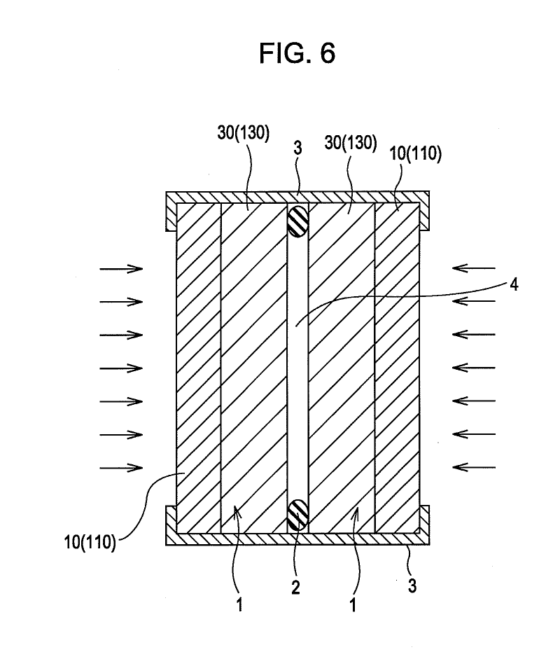

FIG. 1 is an exploded perspective view of an ink jet recording head which is a liquid ejecting head according to an embodiment of the invention. FIG. 2 is a schematic plan view of the ink jet recording head. FIG. 3 is a view taken along line III-III of FIG. 2. FIG. 4 is a cross-sectional view of a state in which a protective substrate is adhered. FIG. 5 is a cross-sectional view of a state in which pressure generation chambers are formed. FIG. 6 is a conceptual diagram of a state in which a channel forming substrate is etched.

The configuration of the ink jet recording head manufactured by the method of the invention will be described with reference to FIGS. 1 to 3.

As shown in the drawings, a channel forming substrate 10 is formed of a silicon single crystal substrate having a plane orientation (110), and an elastic film 50, which is formed of silicon oxide (SiO₂) and is formed by performing thermal oxidation in advance, is formed on one surface of the substrate. In the channel forming substrate 10, a plurality of pressure generation chambers 12 is arranged in parallel along a width direction, and a communicating portion 13 is formed in a longitudinal-direction outer area of the pressure generation chambers 12 of the channel forming substrate 10. The communicating portion 13 and the pressure generation chambers 12 communicate with each other via ink supply paths 14 and communicating paths 15 respectively provided in the pressure generation chambers 12.

The communicating portion 13 communicates with a reservoir portion 31 of a below-described protective substrate and configures a portion of a reservoir which becomes a common ink chamber of the pressure generation chambers 12. Each of the ink supply paths 14 is formed so as to have a width smaller than that of each of the pressure generation chambers 12, and channel resistance of an ink introduced from the communicating portion 13 to each of the pressure generation chambers 12 is constantly maintained by each of the ink supply paths 14.

For example, although, in this example, the ink supply paths 14 are formed by narrowing the width of the channels at one side, the ink supply paths may be formed by narrowing the width of the channels at both sides. Instead of narrowing the width of the channels, the ink supply paths may be formed by narrowing the channels in the thickness direction.

The communicating paths 15 are formed by extending the barrier walls 11 of both sides in the width direction of the pressure generation chambers 12 to the side of the communicating portion 13 and partitioning spaces between the ink supply paths 14 and the communicating portion 13. That is, in the channel forming substrate 10, the ink supply paths 14 having a cross-sectional area smaller than the cross-sectional area in the width direction of the pressure generation chambers 12 and the communicating paths 15 communicating with the ink supply paths 14 and having a cross-sectional area larger than the cross-sectional area in the width direction of the ink supply paths 14 are partitioned by the plurality of barrier walls 11.

In addition, in the channel forming substrate 10, liquid channels including the pressure generation chambers 12, the communicating portion 13, the ink supply paths 14 and the communicating paths 15 are formed. On the inner surfaces of the liquid channels of the channel forming substrate 10, a protective film 16 formed of a material having ink resistance is provided.

In addition, the “ink resistance” described herein is etching resistance for an ink. A nozzle plate 20 is adhered to the opened surface side of the channel forming substrate 10 by an adhesive, a hot welding film or the like, and nozzle openings 21 communicating with the vicinity of the end of the side opposite to the ink supply paths 14 of the pressure generation chambers 12 are formed in the nozzle plate 20. A first hydrophilic treatment layer 17 is provided on the surface of the channel forming substrate 10, to which the nozzle plate 20 is adhered, by performing a hydrophilic treatment, a second hydrophilic treatment layer 22 is provided on the surface of the nozzle plate 20 adhered to the channel forming substrate 10 by performing a hydrophilic treatment, and the first hydrophilic treatment layer 17 and the second hydrophilic treatment 22 are adhered to each other via an adhesive 23.

The elastic film 50 is formed on the side opposite to the opened surface of the channel forming substrate 10, and an insulating film 55 is formed on the elastic film 50. In addition, a lower electrode film 60, a piezoelectric layer 70 and an upper electrode film 80 are laminated on the insulating film 55 so as to configure piezoelectric elements 300. That is, the piezoelectric elements 300 include the lower electrode film 60, the piezoelectric layer 70 and the upper electrode film 80, and configure the pressure generation units.

Generally, any one of the electrodes of the piezoelectric elements 300 is used as a common electrode, and the other electrode and the piezoelectric layer 70 are patterned in the pressure generation chambers 12. In the present embodiment, the lower electrode film 60 is used as the common electrode of the piezoelectric elements 300 and the upper electrode film 80 is used as an individual electrode of each of the piezoelectric elements 300. However, an opposite configuration may be used according to the state of a driving circuit or a wire.

In the above-described example, the elastic film 50, the insulating film 55, and the lower electrode film 60 function as vibration plates, but is not limited to this. For example, the elastic film 50 and the insulating film 55 may not be provided, and only the lower electrode film 60 may function as the vibration plates. Alternatively, the piezoelectric elements 300 may substantially function as the vibration plates.

The piezoelectric layer 70 is formed of a piezoelectric material having an electromechanical transduction property, which is formed on the lower electrode film 60. A crystal film of a perovskite structure is preferably used, and, for example, a ferroelectric material such as lead zirconium titanate (PZT) or the like, a material, which is obtained by adding metal oxide such as niobium oxide, nickel oxide, magnesium oxide or the like thereto, or the like is suitably used. In detail, lead titanate (PbTiO₃), lead zirconate titanate (Pb(Zr, Ti)O₃), lead zirconate (PbZrO₃), lead lanthanate titanate ((Pb, La), TiO₃) lead lanthanum zirconate titanate ((Pb, La) (Zr, Ti)O₃), lead magnesium niobate zirconate titanate (Pb(Zr, Ti) (Mg, Nb)O₃) or the like may be used. The thickness of the piezoelectric layer 70 is suppressed such that crack does not occur in the manufacturing process, and the piezoelectric layer is thickly formed such that sufficient displacement characteristics are obtained.

Lead electrodes 90 which are formed of, for example, gold (Au) or the like are connected to the upper electrode film 80 which is the individual electrode of each of the piezoelectric elements 300, and the lead electrodes 90 are led from the vicinity of the end of the side of the ink supply paths 14 and is extended to the insulating film 55.

A protective substrate 30 having the reservoir portion 31 configuring a portion of the reservoir 100 is adhered on the channel forming substrate 10 in which the piezoelectric elements 300 are formed, that is, on the lower electrode film 60, the elastic film 50 and the lead electrodes 90, via an adhesive 35. The reservoir portion 31 penetrates through the protective substrate 30 in the thickness direction so as to be formed over the width direction of the pressure generation chambers 12, and communicates with the communicating portion 13 of the channel forming substrate 10 so as to configure the reservoir 100 which becomes the common ink chamber of the pressure generation chambers 12.

Alternatively, the communicating portion 13 of the channel forming substrate 10 may be divided into a plurality of portions in each of the pressure generation chambers 12 and only the reservoir portion 31 may function as the reservoir. Alternatively, for example, only the pressure generation chambers 12 may be provided in the channel forming substrate 10, and the ink supply paths 14 communicating with the reservoir and the pressure generation chambers 12 may be provided in a member (for example, the elastic film 50, the insulating film 55 or the like) interposed between the channel forming substrate 10 and the protective substrate 30.

In addition, a piezoelectric element holding portion 32 having a space which does not hinder the motion of the piezoelectric elements 300 is provided in an area opposing the piezoelectric elements 300 of the protective substrate 30. The piezoelectric element holding portion 32 may be sealed or may not be sealed if it has the space which does not hinder the motion of the piezoelectric elements 300.

That is, the piezoelectric element holding portion 32 for covering the piezoelectric elements 300 is formed in the protective substrate 30, and the protective substrate 30 is adhered to the channel forming substrate 10 via the elastic film 50 and the insulating film 55 in a state of covering the piezoelectric elements 300. A head member 1 is configured in the channel forming substrate 10 to which the protective substrate 30 is adhered. As the protective substrate 30, a material having the same thermal expansion as the channel forming substrate 10, for example, a glass or ceramic material or the like may be preferably used. For example, a silicon single crystal substrate which is the same material as the channel forming substrate 10 was used.

A through-hole 33 penetrating through the protective substrate in the thickness direction is provided in the protective substrate 30, and the vicinity of the end of the lead electrodes 90 led from the piezoelectric elements 300 is provided to be exposed in the through-hole 33. A connection wire 220 is formed in a predetermined pattern on the protective substrate 30 (the surface of the side opposite to the adhesion surface with the channel forming substrate), and a driving circuit 200 for driving the piezoelectric elements 300 is mounted on the connection wire 220. As the driving circuit 200, for example, a circuit board, a semiconductor integrated circuit (IC) or the like may be used. The lead electrodes 90 are led from the piezoelectric elements 300 to the outside of the piezoelectric element holding portion 32 and the front ends of the lead electrodes 90 are electrically connected to the driving circuit 200 via a driving wire 210.

In addition, a compliance substrate 40 including a sealing film 41 and a fixed plate 42 is formed on the protective substrate 30. The sealing film 41 is formed of a material with flexibility and low rigidity, and one surface of the reservoir portion 31 is sealed by the sealing film 41. In addition, the fixed plate 42 is formed of a relatively rigid material. An area opposing the reservoir 100 of the fixed plate 42 becomes an opened portion 43 which is completely removed in the thickness direction, and one surface of the reservoir 100 is sealed by only the sealing film 41 having flexibility.

In the ink jet recording head having the above-described configuration, an ink is introduced from an ink introduction port connected to an external ink supplying unit (not shown), and the ink is filled from the reservoir 100 to the nozzle openings 21. Thereafter, a voltage is applied between the lower electrode film 60 and the upper electrode film 80 corresponding to the pressure generation chambers 12 according to a recording signal from the driving circuit 200, and the elastic film 50, the insulating film 55, the lower electrode film 60 and the piezoelectric layer 70 are bent. Therefore, the pressure of the pressure generation chambers 12 is increased so as to eject ink droplets from the nozzle openings 21.

The method of manufacturing the above-described ink jet recording head will be described with reference to FIGS. 4 to 6.

The silicon dioxide film 51 formed of silicon dioxide (SiO₂) configuring the elastic film 50 is formed on the surface of a wafer 110 for the channel forming substrate, which is a silicon wafer including the plurality of channel forming substrates 10 integrally formed therein. The insulating film 55 formed of zirconium oxide is formed on the elastic film 50 (silicon dioxide film 51), and the lower electrode film 60 is formed on the whole surface of the insulating film 55 and is patterned in a predetermined shape. Although the material of the lower electrode film 60 is not specially limited, if lead zirconium titanate (PZT) is used as the piezoelectric layer 70, a material of which a conductive variation hardly occurs due to the diffusion of lead oxide is preferably used. Accordingly, as the material of the lower electrode film 60, platinum, iridium or the like is suitably used.

The piezoelectric layer 70 and the upper electrode film 80 are sequentially laminated on the lower electrode film 60. For example, the piezoelectric layer 70 is formed using a so-called sol-gel method of coating, drying and gelling so-called sol obtained by dissolving and dispersing an organic metal compound in a solvent and performing firing at a high temperature so as to obtain the piezoelectric layer 70 formed of metal oxide.

The method of forming the piezoelectric layer 70 is not limited to the sol-gel method, and, for example, a metal-organic decomposition (MOD) method, a sputtering method, a physical vapor deposition (PVD) method such as a laser ablation method or the like may be used. In addition, as the material of the upper electrode 80, metal having high conductivity, for example, iridium (IR) or the like may be used.

The piezoelectric layer 70 and the upper electrode film 80 are simultaneously patterned so as to form the piezoelectric elements 300. Thereafter, the lead electrodes 90 are formed. A wafer 130 for the protective substrate, which is a silicon wafer and will be divided into the plurality of protective substrates 30, is adhered to the wafer 110 for the channel forming substrate at the side of the piezoelectric elements 300 via an adhesive 35. In the wafer 130 for the protective substrate, the reservoir portion 31, the piezoelectric element holding portion 32, the through-hole 33 and the connection wire 220 are formed in advance.

Next, a mask film 52 is newly formed on the wafer 110 for the channel forming substrate and is patterned in a predetermined shape (the state of FIG. 4). The wafer 110 for the channel forming substrate is anisotropically etched (wet etched) using an alkali solution such as KOH or the like via the mask film 52 such that the pressure generation chambers 12, the communicating portion 13, the ink supply paths 14, the communicating paths 15 and so on corresponding to the piezoelectric elements 300 are formed (the state of FIG. 5).

The etching of the wafer 110 for the channel forming substrate using the alkali solution such as KOH or the like will be described with reference to FIG. 6.

As shown in the drawing, the protective substrates 30 (the wafer 130 for the protective substrate) of the head members 1 each including the protective substrate 30 and the channel forming substrate 10 (the wafer 110 for the channel forming substrate) face each other (the surfaces of the protective substrates 30 at the sides opposite to the adhesion surfaces with the channel forming substrates face each other). The edges of the protective substrates are fixed by a clip 3 as a fixing member with an O-ring 2 interposed between the protective substrates 30 and a sealed space 4 is formed in the inner circumferential side of the O-ring 2. That is, a pair of head members 1 is fixed to each other with the sealed space 4 interposed between the surfaces of the protective substrates 30 at the sides opposite to the adhesion surfaces with the channel forming substrates. At this time, the connection wire 220 (see FIGS. 4 and 5) is arranged in the sealed space 4 in a state of being isolated from the outside. The O-ring 2 is formed of fluororubber with excellent alkali resistance.

By making the sealed space 4 a negative pressure and giving adhesion between the protective substrates 30, the fixing force of the clip 3 may be assisted. In this case, if the crack or the like of the protective substrates 30 can be coped, the fixing force between the head members 1 can be ensured by only the negative pressure, without using the clip 3.

The pair of head members 1 fixed to each other with the sealed space 4 interposed therebetween is, for example, immersed in an alkali solution (KOH) heated to 70° C. to 80° C. and is wet etched, and the pressure generation chambers 12, the communicating portion 13, the ink supply paths 14 and the communicating paths 15 are formed in each of the channel forming substrates 10 of the pair of head members 1. By wet etching the head members 1 by the above-described manufacturing method, the protective substrates 30 are fixed to each other with respect to the sealed space 4 interposed therebetween, the alkali solution (KOH) is not infiltrated into the sealed spaces 4 (the connection wire 220 (see FIGS. 4 and 5) or the like) of the protective substrates 30, and the surfaces of the protective substrates 30 at the sides opposite to the adhesion surfaces with the channel forming substrate (the connection wire 22 (see FIGS. 4 and 5) or the like) can be protected in a state in which melted impurities are not present. Since the protective substrates 30 formed of the same material are fixed, the warpage can be eliminated regardless of the temperature of the alkali solution (KOH).

Accordingly, even when the channel forming substrate 10 is etched by the alkali solution (KOH), it is possible to prevent precision from deteriorating due to a foreign matter and to perform a treatment with high precision, without giving a load to the head members 1. In addition, since the sealed space 4 is formed using the O-ring 2 and the pair of protective substrates 30 are fixed to each other by the clip 3, it is possible to easily form the sealed space 4 with certainty and to fix the protective substrates 30 with certainty. Since the protective film or the like is not used, it is possible to omit a process of removing the protective film or the adhesive.

Although the example in which the pair of head members 1 is fixed with the sealed space 4, in which the connection wire 220 is arranged, interposed therebetween and is wet etched without using the protective film for protecting the connection wire 220 is described, the process of performing the treatment without using the protective film is applicable to a cleaning process of removing a foreign matter such as iron, nichrome or the like.

The pressure generation chambers 12, the communicating portion 13, the ink supply paths 14 and the communicating paths 15 are formed in each of the channel forming substrates 10 of the head members 1, the mask film 52 on the surface of the wafer 110 for the channel forming substrate is removed, and the protective film 16 is formed on the inner surfaces of the pressure generation chambers 12, the communicating portion 13, the ink supply paths 14 and the communicating paths 15. The protective film 16 is formed of, for example, a material having liquid resistance (ink resistance), such as oxide, nitride or the like and is formed by a CVD method. Then, a predetermined cleaning process is performed, a hydrophilic treatment or the like is performed, and the nozzle plate 20 is adhered.

The compliance substrate 40 is adhered to the wafer 130 for the protective substrate, and the wafer 110 for the channel forming substrate and the wafer 130 for the protective substrate are divided by one chip size shown in FIG. 1 so as to form ink jet recording heads.

Although the ink jet recording head is described as an example of the liquid ejecting head in the above-described embodiment, the invention relates to general liquid ejecting heads and is applicable to a liquid ejecting head for ejecting a liquid excluding an ink. The other liquid ejecting heads may, for example, include: various kinds of recording heads used in an image recording apparatus such as a printer; coloring material ejecting head used for manufacturing color filters of a liquid crystal display and the like; an electrode material ejecting head used for forming electrodes of an organic EL display, a FED (field emission display) and the like; a bio-organic matter ejecting head used for manufacturing biochips; and the like.

In addition, it is possible to provide a liquid ejecting apparatus including this liquid ejecting head with high reliability.

1. A method of manufacturing a liquid ejecting head, comprising:
configuring head members each including a first substrate in which pressure generation chambers are provided, pressure generation units which cause a pressure variation in the pressure generation chambers in order to eject liquid droplets from nozzle openings, and a second substrate adhered to the first substrate in a state of covering the pressure generation units, and
facing surfaces of the second substrates of the head members at the sides opposite to adhesion surfaces with the first substrates each other, fixing the pair of head members to each other with a sealed space interposed between the surfaces of the second substrates at the sides opposite to the adhesion surfaces with the first substrates, and performing a solution treatment with respect to the pair of head members fixed to each other.

2. The method according to claim 1, wherein the sealed space is formed by interposing an O-ring between the surfaces of the pair of the second substrates at the sides opposite to the adhesion surfaces with the first substrates.

3. The method according to claim 1, wherein the edges of the pair of second substrates are fixed by a fixing member.

4. The method according to claim 1, wherein wiring members are formed on the surfaces of the second substrates at the side opposite to the adhesion surfaces with the first substrates, and the solution treatment is a treatment for forming the pressure generation chambers by etching using an alkali solution.

5. A liquid ejecting apparatus comprising the liquid ejecting head manufactured by the method according to claim 1.
